(19) United States
(12) Patent Application Publication
(10) Pub. No.: US 2006/0173634 A1
(43) Pub. Date: Aug. 3, 2006

(54) Comprehensive, quality-based interval scores for analysis of comparative genomic hybridization data

(76) Inventors: Amir Ben-Dor, Bellevue, WA (US); Doron Lipson, Tel-Aviv (IL); Zohar H. Yakhini, Ramat Hasheron (IL)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 11/049,183

(22) Filed: Feb. 2, 2005

(51) Int. Cl. G06F 19/00

(52) U.S. Cl. 702/20

(57) ABSTRACT

Embodiments of the present invention are directed to increasing the reliability, precision, and resolution of identification, by analysis of comparative genomic hybridization (“CGH”) data and array-based comparative genomic hybridization (“aCGH”) data, of intervals along one or more chromosomes in which the copy number of the DNA subsequence within the interval in a sample genome is difference from the copy number of the DNA subsequence within a standard, or normal, genome. In various embodiments of the present invention, statistical data-quality measures are incorporated into comprehensive, quality-based interval-scores. In one described embodiment of the present invention, standard deviations for log ratios of signal intensities obtained by instrumental analysis of a microarray are used, along with the log ratios of signal intensities, to compute, for each interval, a weighted interval mean and interval variance, which are mathematically combined to produce a comprehensive, quality-based interval score that can be used to more reliably, precisely, and with greater resolution identify intervals along one or more chromosomes.

The present invention is related to analysis of comparative genomic hybridization data and, in particular, to a method and system for incorporating statistical quality measures into interval scores assigned to intervals of data points associated with loci along chromosomes that are used to identify amplifications, deletions, and other chromosomal abnormalities.

### BACKGROUND OF THE INVENTION

Numerous biological phenomena are related to changes in the number of copies of genes within genomes, and other genomic modifications that involve alterations in DNA subsequences within chromosomes. Gene amplification and entire chromosomal duplication are most spectacularly exhibited in plants, but gene amplification and deletion is also observed in animals, single-cell eukaryotic organisms, eubacteria and archaebacteria. There is strong evidence that a large number of biological innovations that arise through evolution are initially facilitated by gene duplication, providing one or more extra copies of genes that can mutate and evolve to provide new gene products and functionality without depriving an organism of the gene product and function encoded by the original gene. Studies of evolutionary mechanisms and histories often involve reconstructing a timeline of gene duplications and amplifications, followed by a series of probable mutations, that lead to beneficial new genes and functions within a species and even to new species. Amplification and deletion of genes also plays a large role in various different genetic pathologies and various types of cancer. Gene amplification or deletion may be an initial, critical step in the initiation of a cancer, and is frequently observed in states of increasing genomic instability observed during the progression of cancer.

The importance of gene amplification and deletion has both an underlying cause of various biological phenomena, as well as a symptom, or marker, for genomic instability associated with cancer and other pathologies, has elicited significant research and development effort directed to finding methods that allow for identification and quantification of gene deletions, gene amplifications, and other chromosomal abnormalities in particular genomes. One popular method is referred to as comparative genomic hybridization (“CGH”). In the CGH method, one or more normal chromosomes labeled with a first chemical label are isolated from a normal, or standard, tissue or organism, and one or more homologous, potentially abnormal, sample chromosomes labeled with a second chemical label are isolated from a sample tissue or organism. Fragments of the differentially labeled, normal and sample chromosomes are allowed to hybridize to intact, homologous normal chromosomes. Ratios of the amounts of the first label to the amounts of the second detected label along the normal chromosome, obtained by visually or instrumentally scanning the normal chromosome for signals produced by the labels, provide a measure of the degree to which genes have been amplified, deleted, or modified in other ways in the sample chromosome.

More recently, array-based CGH (“aCGH”) has been employed for detecting gene deletion, gene amplification, and other chromosomal abnormalities using microarray technology. In the aCGH technique, fragments of one or more differentially labeled normal chromosomes and potentially abnormal, sample chromosomes hybridize to substrate-bound probe oligonucleotides of a microarray. Each different type of probe oligonucleotide targets a particular locus of a particular chromosome. Analysis of the ratio of the signal intensities detected within a feature containing a particular type of probe oligonucleotide provides a measure of the respective concentrations of the corresponding normal and sample locus in the sample solution or solutions to which the microarray is exposed. After the data is processed and normalized, the ratios of signal intensities for the different features provide a measure of the amplification, deletion, or other abnormalities associated with particular loci targeted by probe molecules.

Analysis of the raw aCGH signal-intensity ratios may provide a relatively finely grained, or high resolution, map of the relative number of gene copies, or other DNA-subsequence copies, in a sample genome with respect to a normal, or standard, genome. One method for aCGH data analysis involves identifying intervals of loci along one or more chromosomes with measured interval scores of highest magnitude, the intervals representing stretches of successive loci along a chromosome having a constant copy number in the sample genome. Visual inspection or automated analysis of the results of interval analysis often immediately reveal portions of a chromosome or chromosomes that have been amplified, deleted, or otherwise changed in the sample genome.

Both CGH and aCGH data can be noisy, with relatively large variances in measured signal-intensity ratios. Noise may lead to imprecision in identifying intervals within chromosomes, and a low resolution, and frequently inaccurate map of chromosomal abnormalities. For this reason, developers and manufacturers of equipment used for CGH and aCGH data analysis, as well as microarray-data-analysis-software vendors, vendors of CGH-data-analysis software, and researchers and diagnosticians who employ CGH and aCGH analysis, have all recognized the need for methods and systems for CGH and aCGH data analysis that provide more precise and reliable identification, from CGH and aCGH data, of loci intervals in which a constant, copy-number variation is observed between a normal, or standard, genome and a sample genome.

### SUMMARY OF THE INVENTION

Embodiments of the present invention are directed to increasing the reliability, precision, and resolution of identification, by analysis of comparative genomic hybridization (“CGH”) data and array-based comparative genomic hybridization (“aCGH”) data, of intervals along one or more chromosomes in which the copy number of the DNA subsequence within the interval in a sample genome is difference from the copy number of the DNA subsequence within a standard, or normal, genome. In various embodiments of the present invention, statistical data-quality measures are incorporated into comprehensive, quality-based interval-scores. In one described embodiment of the present invention, standard deviations for log ratios of signal intensities obtained by instrumental analysis of a microarray are used, along with the log ratios of signal intensities, to compute, for each interval, a weighted interval mean and interval variance, which are mathematically combined to produce a comprehensive, quality-based interval score that can be used to more reliably, precisely, and with greater resolution identify intervals along one or more chromosomes.

### BRIEF DESCRIPTION OF THE DRAWINGS

FIG. 1 illustrates an array-based experiment.

FIG. 2 illustrates a hypothetical aCGH experiment.

FIG. 3 illustrates, in the same fashion as FIG. 2, a hypothetical aCGH experiment in which a sample chromosome contains a deleted subsequence.

FIG. 4 illustrates a third, hypothetical aCGH experiment in which a sample chromosome contains an amplified subsequence.

FIGS. 5A-F illustrate various sources of noise encountered at the feature level in microarray data.

FIG. 6 shows a plot of two different normal distributions.

FIG. 7 shows hypothetical log-ratios of measured signal intensities, generated during a hypothetical aCGH experiment, plotted in loci-occurrence order.

FIGS. 8A-D illustrate two different, possible step-like profiles that may be drawn through the log-ratios of signal intensities plotted in FIG. 7.

FIG. 9 illustrates a hypothetical, step-like profile generated by an embodiment of the present invention for the log ratios of signal-intensities plotted in loci-occurrence order in FIG. 7.

FIG. 10 illustrates characteristics of an interval of log ratios of signal intensities plotted in loci-occurrence order that contribute to high comprehensive, quality-based interval scores.

### DETAILED DESCRIPTION OF THE INVENTION

Embodiments of the present invention are directed to techniques for improving interval identification during analysis of CGH and aCGH data in order to detect chromosomal abnormalities in chromosomes of a sample tissue or organism. Various embodiments of the present invention use a comprehensive, quality-based interval score to facilitate identification of intervals, or DNA subsequences, along one or more chromosomes of the sample tissue or organism that have a constant copy number in the genome of the sample tissue or organism different from the copy number of the interval in a standard, or normal, tissue or organism genome. The described embodiments involve oligonucleotide-probe-based aCGH experiments, but the present invention is applicable to many other currently used CGH methods involving bacterial artificial chromosomes, cDNA, and other target and probe molecules, mediums, and techniques.

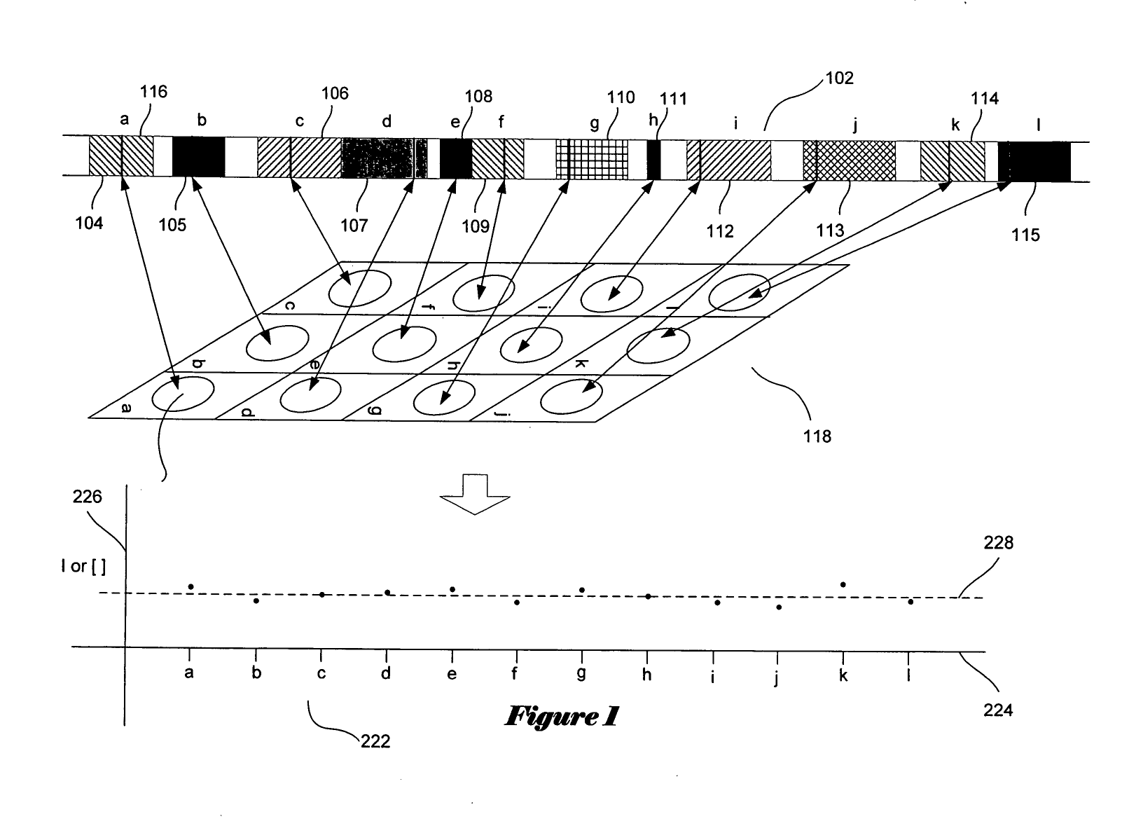

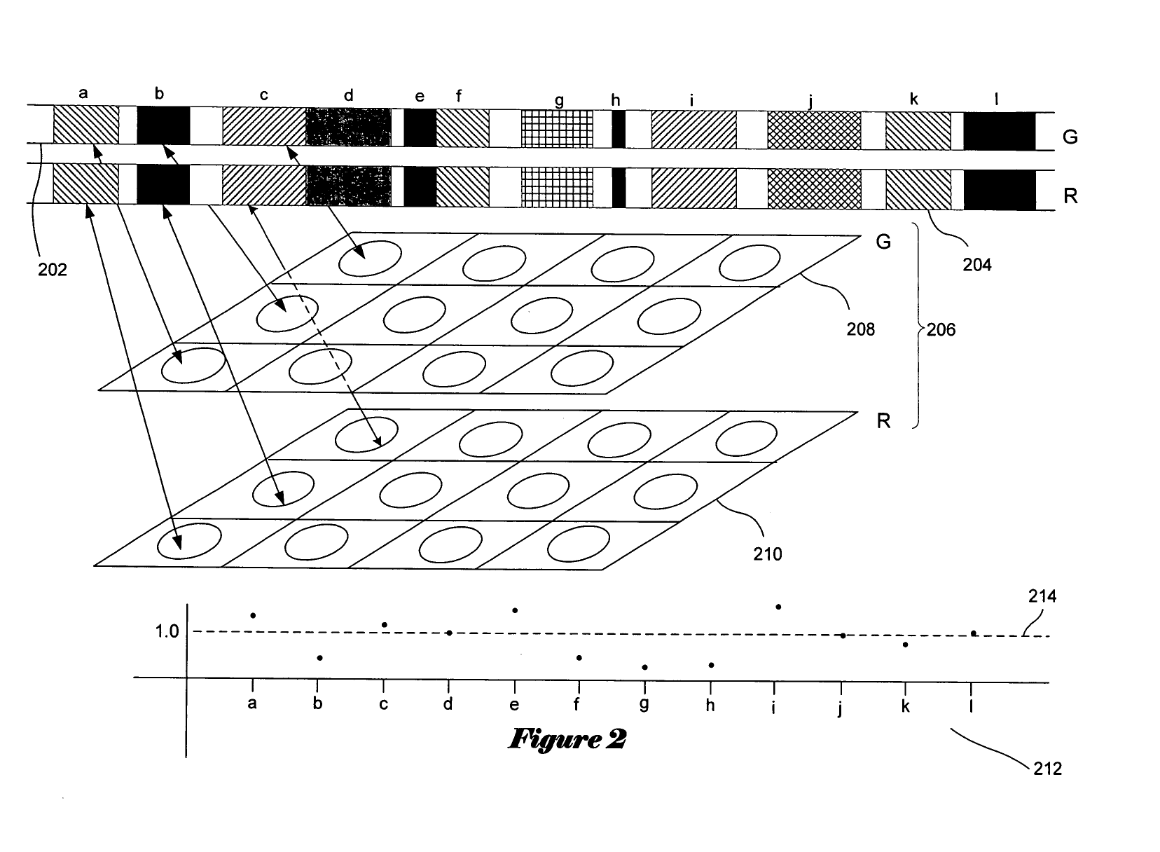

FIG. 1 illustrates an array-based experiment. It should be noted that FIG. 1, and FIGS. 2-4, discussed below, employ a tiny, exemplary portion of a hypothetical chromosome and a corresponding, tiny region of a microarray in order to illustrate concepts of aCGH experiments. However, in actual aCGH experiments, multiple chromosomes, each containing thousands of genes and corresponding target loci, may be analyzed using microarrays containing tens of thousands of features, each feature containing one particular type of probe oligonucleotide molecule targeting a particular locus within a particular chromosome.

At the top of FIG. 1, an abstract representation of a portion 102 of a chromosome is shown. This portion 102 of the chromosome contains genes a-l 104-115, distinguished in FIG. 1 by different shadings and crosshatching. In the example shown in FIG. 1, each gene contains a particular locus, such as locus 116 in gene a 104, represented in FIG. 1 by a dark, vertical line, that is a small subsequence of the gene to which a particular probe on the exemplary microarray 118 targets. For example, locus 116 of gene a 104 is targeted by probe molecules bound to the substrate of the microarray 118 in feature 120. Although, in the described hypothetical experiments, loci are considered to be associated with genes, target loci in actual aCGH experiments may be subsequences of non-protein-encoding regions of chromosomal DNA, such as control elements, ribosomal-RNA-encoding regions, and other non-protein-encoding regions of a chromosome sequence, in addition to genes.

Chromosomes each contain two linear polymers of deoxynucleosides, biologically synthesized by the condensation of deoxynucleoside triphosphates. These polymers, each referred to as a deoxyribonucleic acid (“DNA”), encode information in the particular sequence of the four different deoxynucleoside monomers: adenylate, guanylate, thymidylate, and cytidylate. Each chromosome consists of two, sequence-complementary, anti-parallel strands of DNA. These strands are sequence complementary in that an adenylate monomer on one strand is paired with a thymidylate monomer on the complementary strand, and a guanylate monomer on one strand is paired with a cytidylate monomer on the complementary strand. The two polymer strands are held together in a familiar double-helix confirmation by various inter-molecular forces, including base-stacking interactions, ionic interactions, hydrogen bonding, and other non-covalent, attractive forces. The strands interact most strongly when the nucleoside-monomer sequences are exactly complementary, but two DNA polymers with only partial complementarity may nonetheless associate together in a modified double-helix conformation. When a first strand binds to a second, complementary strand, the first strand is said to hybridize with the second strand.

The two strands of a chromosome can be disassociated from one another under certain, well-known temperature and/or ionic-strength conditions, in a process known as “melting,” to produce free, non-hybridized strands of chromosomal DNA. For an aCGH experiment, one or more types of chromosomes in a sample solution are melted, or denatured, and fragmented in order to produce small, single-strand fragments of both strands of the chromosome. A microarray contains many tens of thousands of features, each feature containing one type of probe oligonucleotide that specifically targets a particular locus, or small subsequence, of one strand of a chromosome. When the microarray is exposed to a solution of short, single-stranded fragments of one or more chromosomes, fragments complementary to a particular probe molecule tend to end up bound to the feature containing that type of probe molecule. The sample, chromosomal DNA is labeled with a chromophore, radioisotope, or other signal-producing label, so that hybridization of short, single-stranded DNA fragments to microarray features can be instrumentally detected as optical signals produced by label chromophores or as radioactive emission produced by radioactive labels.

The signal intensities measured for each feature of the microarray provide a measure of the sample-solution concentration of the chromosomal locus, or short chromosomal subsequence, targeted by the probe oligonucleotide bound to that feature. Thus, in the example illustrated in FIG. 1, the signals measured for each of the features of the microarray 118 can be plotted in a graph 122 to show the relative concentrations of the loci to which probe oligonucleotides of the features are targeted, or, in other words, with which the probe oligonucleotides complementary in sequence. In the example shown in FIG. 1, the microarray 118 is exposed to a sample solution containing short, single-stranded fragments of a large number of identical copies of the chromosome portion 102 shown at the top of FIG. 1. It would be expected that the 12 loci, corresponding to the 12 genes in the chromosomal fragment, would have identical concentrations in the sample solution, and produce identical signals. As seen in the plot 222 at the bottom of FIG. 1, in which the horizontal axis 224 corresponds to the sequence-relative positions of the loci along the chromosome and the vertical axis 226 corresponds to the measured signal intensity or concentration of each locus in the sample solution to which the microarray is exposed, the measured signal intensities, or inferred concentrations, of all 12 loci fall close to a single, average signal intensity or concentration represented by the dashed, horizontal line 228 in plot 222. The variation in measured signal intensities, or concentrations, for the 12 loci result from a number of types of instrumental and experimental errors, discussed below.

In an actual aCGH experiment, the microarray is generally exposed either to two different solutions, each prepared from a different organism or tissue, or to a solution containing fragments from one or more chromosomes obtained from two different tissues or organisms. The aCGH experiment allows the relative concentrations of loci isolated from two different tissues or organisms to be compared.

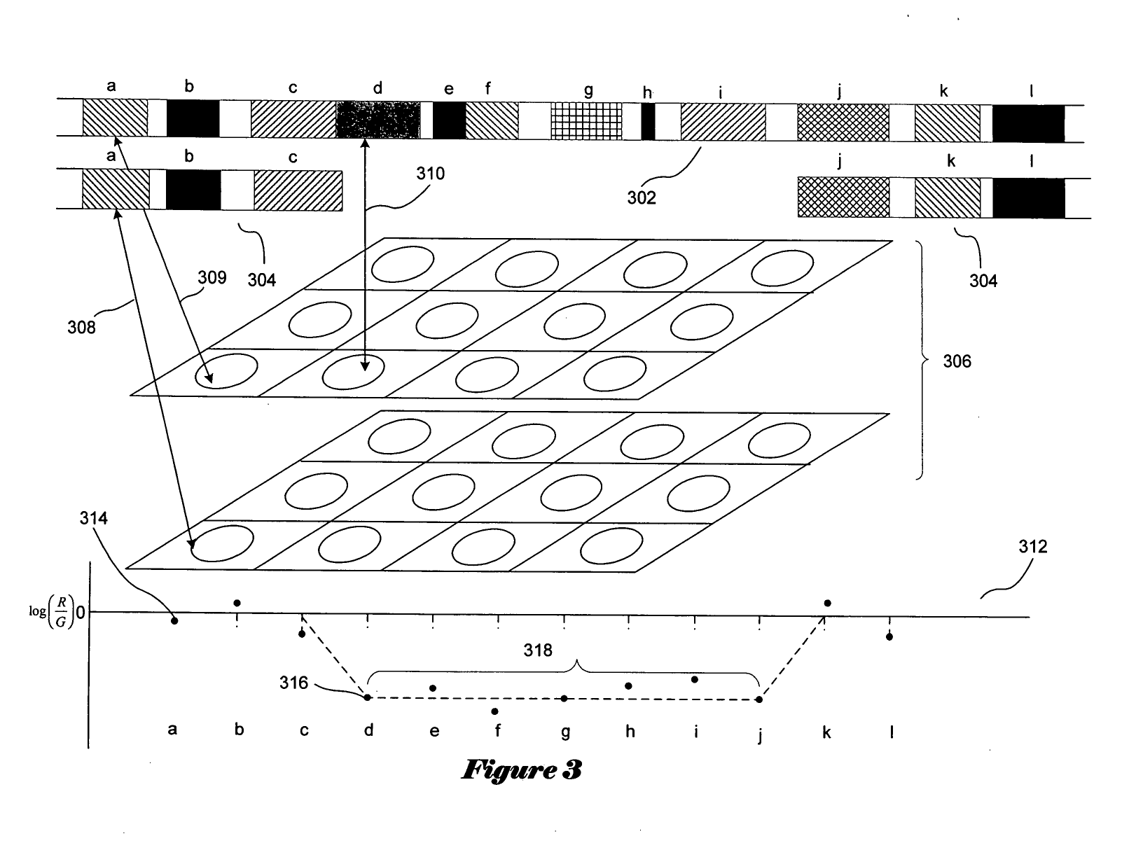

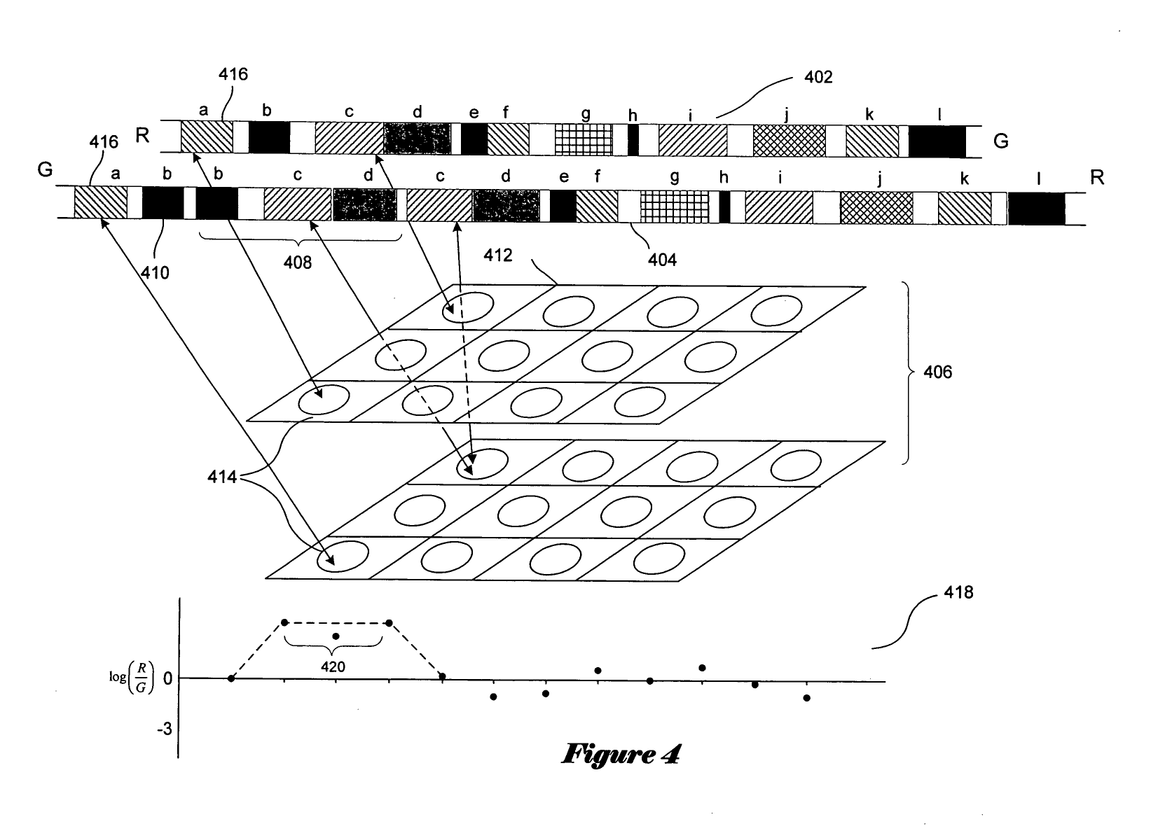

FIG. 2 illustrates a hypothetical aCGH experiment. In FIG. 2, a first, abstractly represented chromosome 202 corresponds to a portion of a normal chromosome isolated from a normal, or standard, tissue or organism. The second abstractly represented chromosome 204 corresponds to a portion of a chromosome isolated from a potentially abnormal, sample tissue or organism. The portion of the normal chromosome 202 is labeled with a first type of chemical label G, and the portion of the potentially abnormal, sample chromosome 204 is labeled with a different label R. In one common aCGH technique, chromosomal material from one tissue or organism is labeled with a first chromophore that fluoresces at a first wavelength, or color, and the potentially abnormal chromosomal material is labeled with a second chromophore, that fluoresces at a second wavelength, or color. It is common to refer to the first chromophore used to label the chromosomal DNA of a standard, or normal, tissue or organ as the green chromophore, and to refer to the second chromophore used to label the chromosomal DNA of a sample tissue or organ, such as a tissue or organ biopsy, as the red chromophore—hence the designations R and G in the example illustrated in FIG. 2, and subsequent examples illustrated in FIGS. 3 and 4. Any of many different labels may be used in actual experiments, provided that each type of label produces a signal distinguishable from other types of labels used in the experiment.

In FIG. 2, a small portion of a microarray 206 is represented as two, distinct microarray layers 208 and 210, corresponding to separate detection of the red signal and the green signal. As discussed above, simple aCGH experiments generally use a single microarray that is instrumentally analyzed to detect both red and green signals emanating from each feature, although multiple-array-based experiments are also possible. In the example aCGH experiment shown in FIG. 2, the microarray 206 is first exposed to a solution containing short, single-stranded fragments of a large number of identical copies of the normal chromosomal portion 202, labeled with red chromophore, and then exposed to a sample solution containing short, single-stranded fragments of a large number of identical copies of the potentially abnormal chromosomal portion 204, labeled with green chromophore. It can be assumed that the concentrations of normal loci in the first solution are equivalent to the concentrations of the sample loci in the second solution, although an overall difference in concentration of the starting chromosomal material for normal and sample tissues or organisms is easily corrected for, and largely irrelevant. Alternatively, the microarray may be exposed to a single solution containing differentially labeled fragments of both normal and sample chromosomes. The microarray 206 is then processed and instrumentally analyzed to produce ratios of the red-to-green signals,

$$\frac{{R}_{i}}{{G}_{i}} ,$$

for each feature i. The measured red-to-green signal ratios for the 12 loci are plotted in plot 212 in FIG. 2. The measured signal ratios all fall close to the value 1.0, represented by the dashed line 214 in plot 212, since equal numbers of red-labeled and green-labeled fragments for each locus should have hybridized to each feature corresponding to the locus, under the experimental conditions described above.

More interesting aCGH results are obtained when the sample chromosome or chromosomes differ in sequence from the normal, or standard chromosome or chromosomes to which they are compared in an aCGH experiment. FIG. 3 illustrates, in the same fashion as FIG. 2, a hypothetical aCGH experiment in which a sample chromosome contains a deleted subsequence. The normal chromosome portion 302 shown in FIG. 3 is identical to that shown in FIGS. 2 and 1. However, a subsequence has been deleted from the sample chromosome portion 304 shown in FIG. 3, with respect to the normal chromosomal portion. The deleted subsequence includes portions of genes c and j, as well as the entire sequences of genes d, e, f, g, h, and i. Therefore, while equal amounts of labels R and G should be found in a feature corresponding to a locus present both in the normal chromosomal portion and the abnormal chromosomal portion, such as the locus within gene a, as represented in FIG. 3 by the two arrows 308-309, only the label R should appear in a feature targeting a locus within a gene omitted from the abnormal chromosomal portion, such as gene d, as shown in FIG. 3 by the single arrow 310. In actual aCGH experiments, the log ratio of the red-to-green signal intensities,

$$log ( \frac{{R}_{i}}{{G}_{i}} ) ,$$

is generally produced as output from the microarray reader for each locus i.

The measured log ratios for the 12 loci measured in the hypothetical experiment shown in FIG. 3 are plotted in plot 312, at the bottom of FIG. 3. The log ratios for the loci within genes occurring both in the normal and abnormal chromosomal portions are close to zero, such as the log ratio for the red and green signals measured for gene a 314, while the log ratios corresponding to loci within genes deleted from the abnormal chromosomal portion have low values, such as the log ratio 316 measured for gene d. Of course, if no red-labeled fragments were to hybridize to a feature to which significant concentrations of green-label fragments hybridize, the theoretical log ratio would approach −∞. However, in practical experiments, the measured signal rarely falls to zero, and log ratios less than a predetermined, threshold value are generally set to a minimum value. As can be seen in the exemplary plot 312 in FIG. 3, the region of negative, log-ratio values 318 exactly corresponds to the subsequence deleted from the abnormal chromosomal portion 304.

FIG. 4 illustrates a third, hypothetical aCGH experiment in which a sample chromosome contains an amplified subsequence. As with the hypothetical experiments discussed above, with reference to FIGS. 2 and 3, the experiment illustrated in FIG. 4 involves a normal, or standard, chromosomal portion 402 that includes 12 genes containing 12 loci targeted by features of a hypothetical microarray 406. However, in the experiment illustrated in FIG. 4, the sample, or potentially abnormal, chromosomal portion 404 includes a short duplicated region 408 inserted between genes b 410 and c 412. Thus, in the sample chromosomal portion 404, there are two copies of genes b, c, and d. As shown by the double arrows in FIG. 4, those features, such as feature 414, containing an oligonucleotide-probe-type directed to a locus within gene, such as gene a 416, with equal numbers of copies in the sample chromosomal portion 404 and the normal, or standard chromosomal portion 402, should produce equal green and red signal intensities, following data extraction and normalization. However, in the case of a gene duplicated in the sample chromosomal portion 404, such as gene c, twice as much red label as green label should end up bound to the feature directed to the gene. As shown in the plot 418 of the log ratios of signal intensities produced by instrumental analysis of the hypothetical array 406, the measured log ratios for the duplicated genes 420 have positive values well above the zero value expected for genes having an equal number of copies in the normal chromosomal portion and the sample chromosomal portion. The magnitudes of the log ratios reflect the disparities in copy number of loci in the genomes of normal and sample tissues or organs.

Considering the hypothetical aCGH experiments discussed above, with reference to FIGS. 2-4, it is apparent that if the normalized log ratios for two-label experiments involving one or more chromosomes isolated from a normal, or standard, tissue or organism labeled with one chromophore and one or more chromosomes isolated from a sample tissue or organism labeled with a second chromophore, a plot of the log ratios of signal intensifies in order of the occurrence of corresponding loci along the one or more chromosomes may generate a step-like profile in which intervals of consecutive loci having significantly positive or significantly negative log ratios correspond to intervals of the sample chromosome or chromosomes that have been deleted or amplified with respect to the normal, or standard chromosome or chromosomes. Were the log-ratio data collected from microarrays used in aCGH experiments to have sufficiently low noise, identification of gene deletions, gene amplifications, and other abnormalities could be straightforwardly carried out by visual or automated analysis of loci-occurrence-ordered log-ratio plots. Actual log-ratio data, however, tends to be noisy.

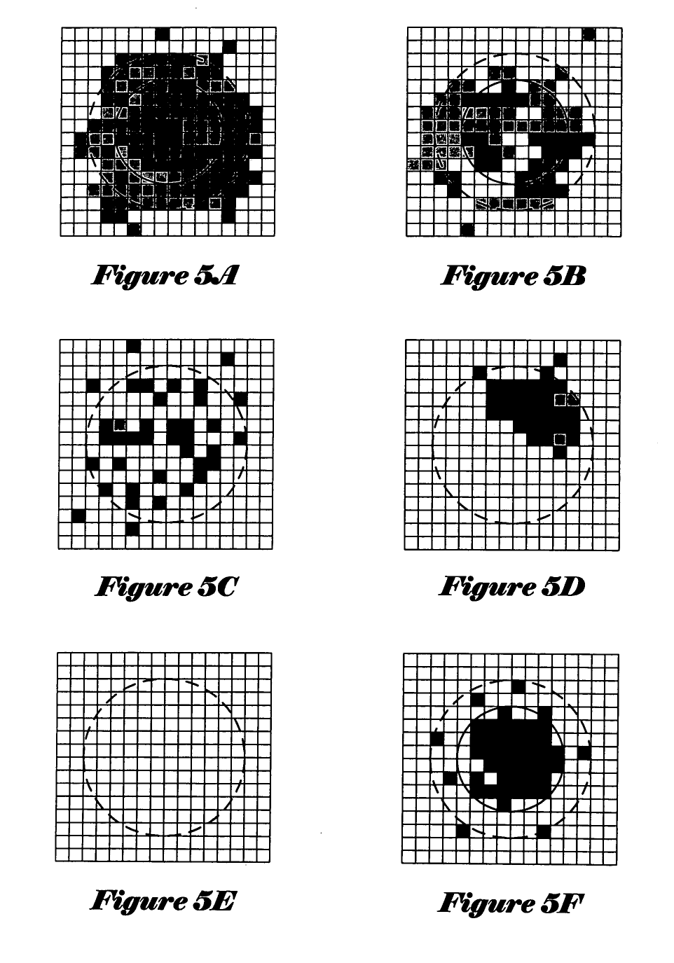

FIGS. 5A-F illustrate various sources of noise encountered at the feature level in microarray data. FIG. 5A shows a rectangular region 508 of an image read from a microarray by a microarray reader. The region 502 is divided into small, rectangular pixels, such as pixel 504. Each pixel is associated with at least one signal intensity. In two-label experiments, such as those discussed above with reference to FIGS. 2-4, each pixel is associated with two signal intensities, one for the red chromophore and one for the green chromophore. Three, four, and more labels may be concurrently used in single experiments, with pixels associated with three, four, or more signal intensities, each corresponding to a different chromophore or label, allowing for comparison of the relative loci copy numbers of multiple different samples to loci copy numbers in one or more normal chromosomes. In FIGS. 5A-F, the darkness of coloration of the pixels corresponds to the intensity measured for one signal emanating from one label, with greater signal intensities associated with darker pixels.

The rectangular region 502 shown in FIG. 5A includes one, centered feature. Feature extraction software is used to identify and quantify features in a microarray data set. Certain types of feature-extraction software automatically locate the area of a feature, such as the area enclosed in the solid circle 506 in FIG. 5A, as well as a feature background, the annular area between the solid circle 506 and a dashed circle 508 in FIG. 5A, that is used for statistical characterization of the signal intensity measured for the feature. In the case shown in FIG. 5A, the image of the feature is well centered, and the area of the feature, within the solid circle 506, contains pixels of relatively uniform intensity. Moreover, the background annulus also contains pixels of reasonably uniform intensity, allowing for a reasonably high-quality statistical analysis. However, even in the case shown in FIG. 5A, there is variation in the intensities of the pixels, both within the feature and the background annulus. Instability in detector electronics, errors in microarray positioning, non-uniformities in probe synthesis or application to the microarray, non-homogeneities in sample solutions, and other such sources of experimental and instrument error may all contribute to a natural and generally unavoidable variance in pixel intensity within and surrounding a feature.

However, variances can often be significantly higher for particular features in a microarray-derived data set. For example, as shown in FIG. 5B, the overall intensities of pixels within features may be significantly less than the intensities predicted from concentrations of the target molecule in a sample to which the microarray is exposed. Such effects may be observed throughout an array, or over large sections of an array, and may often be corrected during data analysis by various normalization techniques using intensities read from control features. More problematic are large pixel-intensity variations within a feature, as shown in FIG. 5C. In such cases, it is difficult to ascertain whether the scattered, high-intensity pixels represent aberrant measured pixel intensities, or, whether the scattered, low-intensity pixels are aberrant. Occasionally, as shown in FIG. 5D, only a portion of the area of a feature includes above-background pixel intensities, often indicative of microarray-manufacturing errors, such as improper application of probes or probe monomers, or array-handling errors, in which the surface of the microarray is scratched or abraded. Occasionally, as shown in FIG. 5E, no signal is obtained for a feature containing probe molecules that target molecules known to have been present in the solution to which the microarray was exposed. Such errors may be due to unforeseen interaction between target molecules and other molecules in sample solutions, instrumental error, or other sources of error. Another commonly encountered problem, as shown in FIG. 5F, is that, although the feature has reasonable uniform intensity, the background area surrounding the feature is found to have a relatively high variance in pixel intensities, leading to poor statistical quality metrics for the feature. The types of errors and anomalies discussed with reference to FIGS. 5B-F are but a few of many different types of errors observed in microarray data sets, including aCGH data sets.

Feature-extraction and other data-analysis software employ a variety of methods for normalizing intensity data and detecting and ameliorating various types of errors, particularly systematic errors, in order to produce accurately measured log ratios of signal intensities. However, the log-ratio data is associated with an inherent variability arising from manufacturing, instrumental, and experimental errors, and the data-extraction and data-analysis software provide, in addition to the measured log-ratio values, a standard deviation for each measured log-ratio value, indicative, in certain methods, of the detected variance in pixel intensities over the area in the image of the feature from which the log-ratio value is obtained. In other methods, other measurable quantities are used as the basis for a statistical analysis of log-ratio data. Embodiments of the present invention may employ any of a large number of differently computed and numerically expressed quality metrics associated with log-ratio data, including many different types of statistically derived quality metrics.

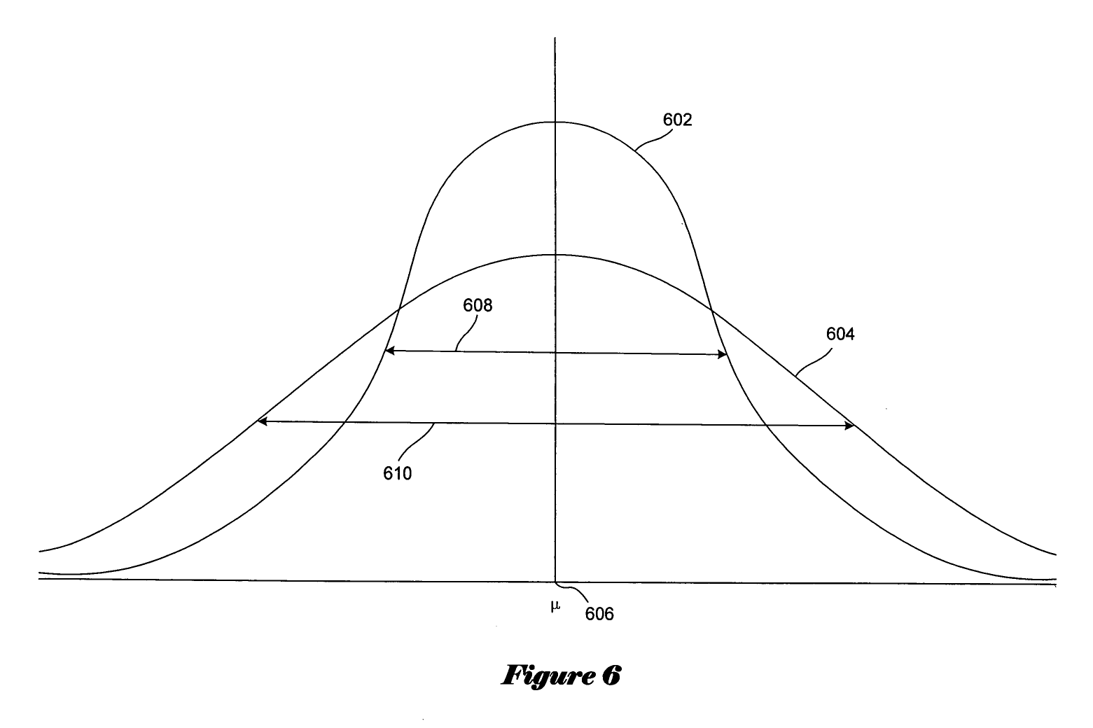

The variance associated with a log-ratio value may be modeled by any of a number of different statistical probability distributions. In some cases, the distribution of log-ratio values may be modeled by a normal distribution:

$$f ( y ) = \frac{1}{σ \sqrt{2 π}} {ⅇ}^{[ - \frac{1}{2 {σ}^{2}} {( y - μ )}^{2} ]}$$

where y is a measured value for random variable Y,
σ is the standard deviation, and
μ is the mean measured value for the random variable Y.
FIG. 6 shows a plot of two different normal distributions. In FIG. 6, a first distribution 602 has less variability than a second distribution 604. Both distributions are symmetrical about a common mean 606. The variance associated with the distribution is related to the width of the distribution at one-half the height of the peak of the distribution, at the mean μ. Thus, the width 608 at one-half of the peak height of the distribution with lower variance 602 is less than the width 610 at one-half of the peak height of the distribution with larger variance 604. When discrete data are collected, the mean is computed as:

$$μ = \frac{{\sum }_{i = 1}^{n} {y}_{i}}{n}$$

and the variance and standard deviations are computed as:

$$variance = {σ}^{2} = \frac{{\sum }_{i = 1}^{n} {( {y}_{i} - μ )}^{2}}{n}$$

$$standard deviation = σ = \sqrt{{σ}^{2}}$$

Thus, the standard deviation, computed by feature-extraction software for a log ratio value measured for a feature using observed variance in feature pixels, is an indication of the expected variability in the log ratio value if the log ratio value were to be repeatedly measured from a number of equivalent features under equivalent experimental and instrumental conditions. The standard deviation is, in other words, a statistical measure of the log-ratio-value quality.

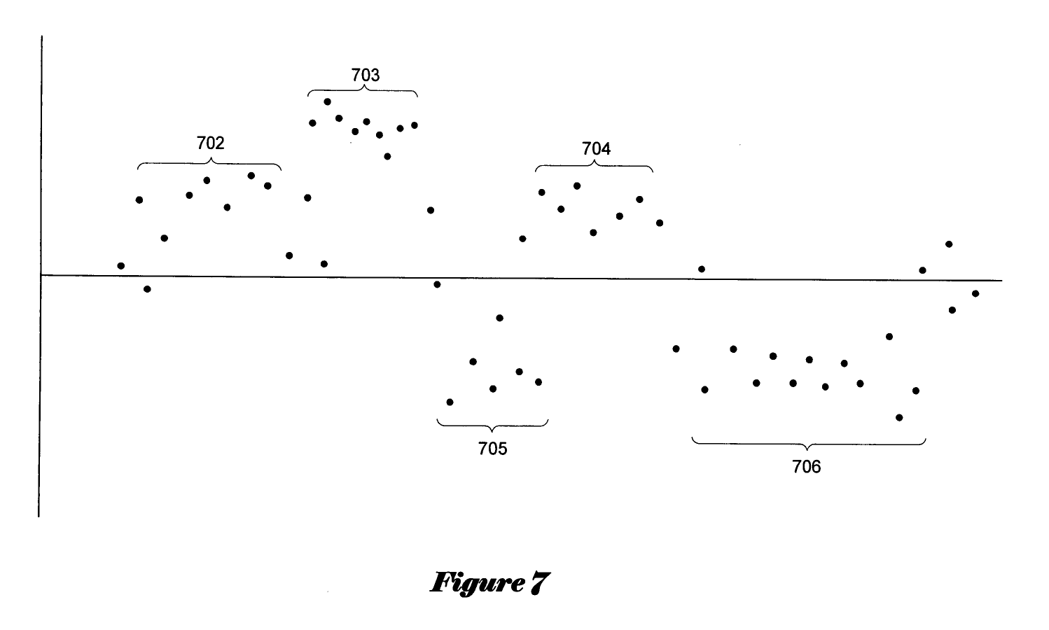

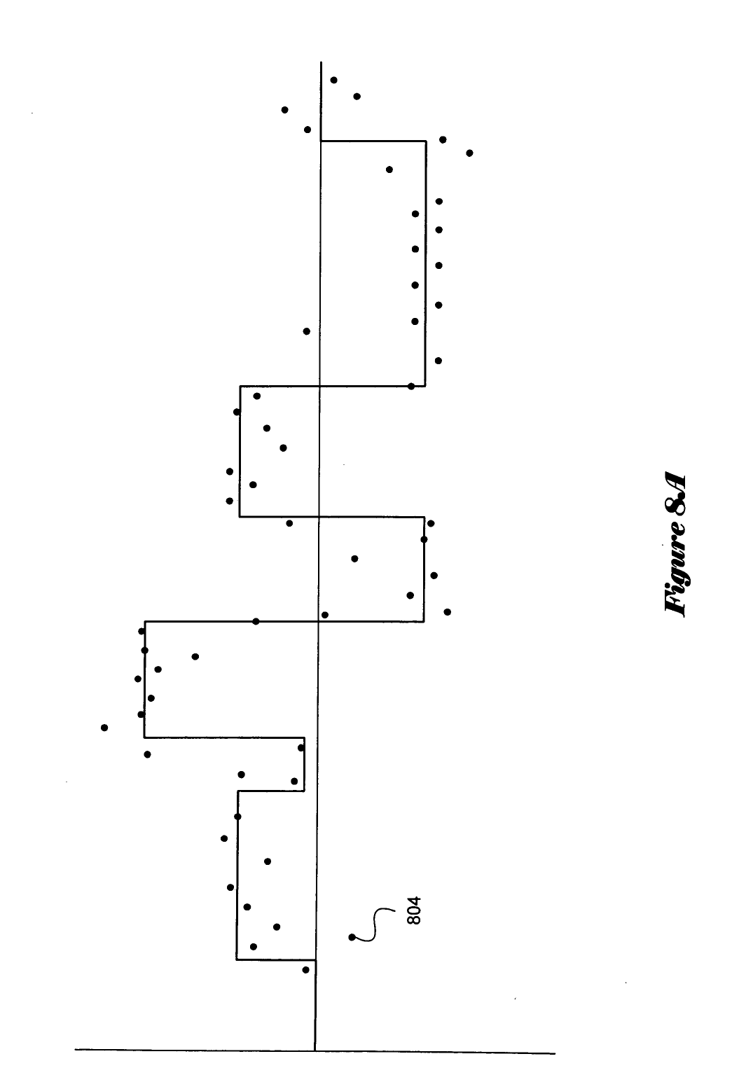

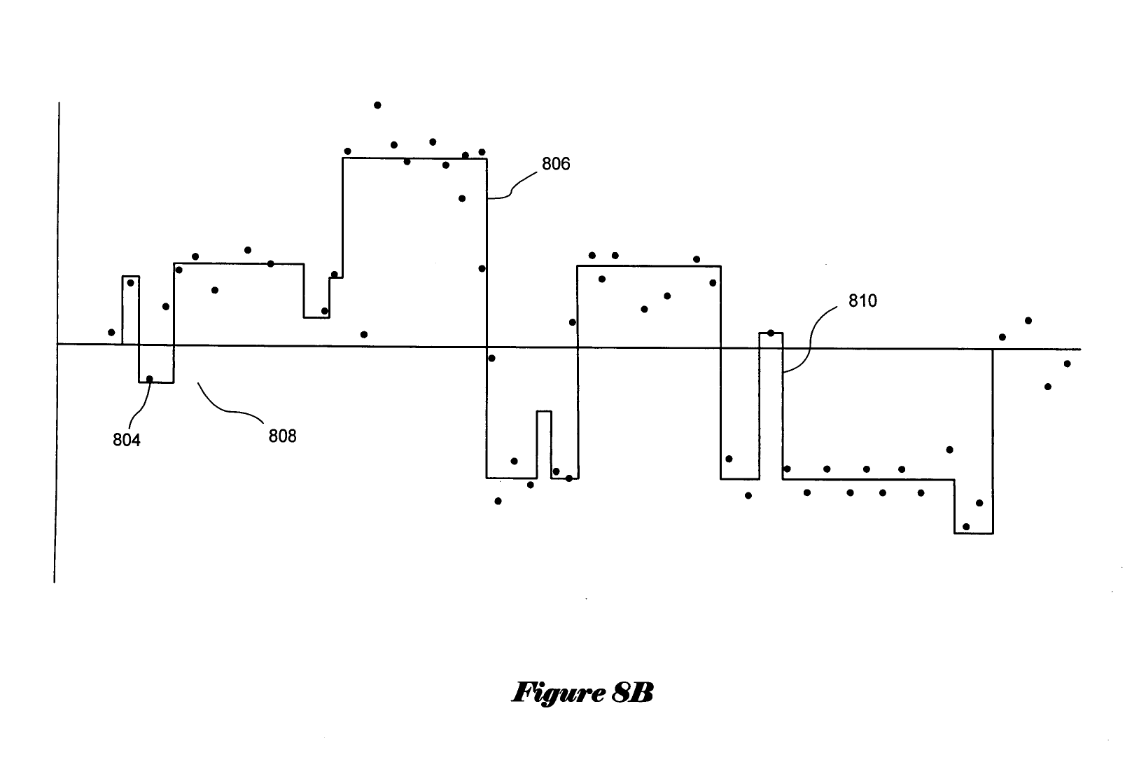

As a result of the inherent variance in log-ratio data, measured log-ratio values for features targeting loci in a genome, plotted in order of loci occurrence, as in the plots shown in FIGS. 2-4, often do not end up providing a clear, step-like profile indicative of gene deletions and amplifications, as discussed above. Instead, the data tends to be noisy. FIG. 7 shows hypothetical log-ratios of measured signal intensities, generated during a hypothetical aCGH experiment, plotted in loci-occurrence order. In the portion of the data set plotted, it would appear that gene deletion may have occurred in the intervals 702-704, while gene amplification may have occurred in intervals 705 and 706, providing, of course, that the log ratios are computed for normal and sample solutions as in the hypothetical experiments discussed above with reference to FIGS. 2-4. However, construction of a step-like profile through the noisy data point shown in FIG. 7 may lead to markedly different, possible profiles, depending on how data points are viewed. FIGS. 8A-B illustrate two different, possible step-like profiles that may be drawn through the log-ratios of signal intensities plotted in FIG. 7. Note, for example, that in the profile generated in FIG. 8A 802, data point 804 has been ignored, considered as an outlier to the general trend of increased log-ratio values in neighboring points, while in the profile 806 generated in FIG. 8B, data point 804 is considered significant, causing a narrow well 808 in the profile suggestive of a short stretch of gene amplification. Such ambiguities may lead to low granularity in identification of amplified and deleted sequences, or low resolution, or may, by contrast, lead to false, narrow, apparently high resolution intervals. Thus, as in many experimental systems, the precision, accuracy, reliability, and resolution of the final data analysis may directly depend on the amount of noise in the data.

Many different computational techniques can be used to identify subsequences, or intervals, along one or more chromosomes that are amplified, deleted, or exhibit other abnormalities, from aCGH data such as the hypothetical data plotted in FIG. 7 and discussed with reference to FIGS. 2-4. In one technique, all possible intervals within a chromosomal region are considered by assigning to each possible interval an interval score. The higher the interval score, the more likely that the interval will be selected as corresponding to a region of gene amplification. The lower the interval score, the more likely that the interval will be selected as corresponding to a region of gene deletion. Other interval scores or interval-score trends may be indicative of other types of abnormalities. In mathematical notation, the genomic interval is represented as I, having a length, in successive loci, of k=|I|. The log ratio of measured signal intensities for each loci i are represented as

$${c}_{i} = log ( \frac{{R}_{i}}{{G}_{i}} ) .$$

One useful interval score S(I) is computed as follows:

$$S ( I ) = {\sum }_{i ∈ I} ( \frac{{c}_{i}}{\sqrt{k}} )$$

When used in the interval-identifying computational techniques, this interval score tends to favor longer stretches of loci with consistently large positive or consistently large negative log ratios. Interval-finding computational techniques are generally recursive, however, and may lead to ambiguities in profile generation such as those discussed above with reference to FIGS. 8A-B.

Embodiments of the present invention are directed to a more comprehensive, quality-based interval score that can be used in interval-finding computational methods to identify chromosomal abnormalities from aCGH data. In numerous embodiments of the present invention, the more comprehensive, quality-based interval score includes both the log ratios of signal intensities, cᵢ, as well as the computed standard deviations of the log ratios of signal intensities. In other words, the comprehensive, quality-based interval score is based both on signal-intensity data as well as on a measure of the statistical quality of the signal-intensity data.

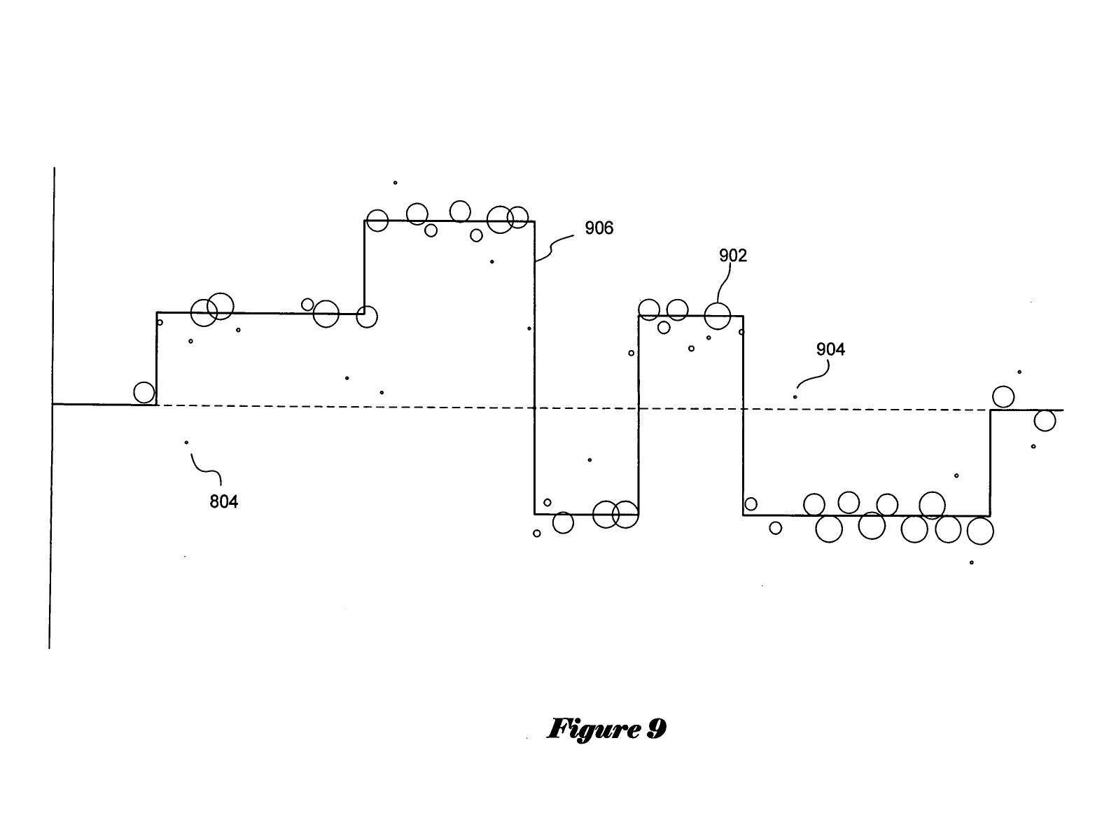

FIG. 9 illustrates a hypothetical, step-like profile generated by an embodiment of the present invention for the log ratios of signal-intensities plotted in loci-occurrence order in FIG. 7. In FIG. 9, the data points, or plotted log ratios of signal intensities, are plotted as circles of varying radii, such as circles 902 and 904. The magnitude of the radius of a plotted data point is directly proportional to the statistical quality of the log-ratio data. In other words, the smaller the computed standard deviation for a log ratio, the larger the radius of the circle used to plot the log ratio, and the higher the statistical quality of the log ratio. Intervals are then calculated based on a comprehensive, quality-based interval score that factors in both the magnitudes of the log ratios of the signal intensities and the statistical quality of the log ratios of the signal intensities. This provides for less ambiguity and greater resolution in assigning data points to intervals.

Consider data point 804 in FIG. 9 which, as discussed with respect to FIGS. 8A-B, is a source of profile ambiguity when intervals are identified based on the previously discussed interval score S(I). The ambiguity is largely removed, in FIG. 9, because data point 804 is seen to have extremely low quality, or a high measured standard deviation. Therefore, it is reasonable to discount data point 804 in constructing the profile 906 shown in FIG. 9. A similar ambiguity introduced by data point 904, which elicits a narrow profile peak 810 in the profile 806 shown in FIG. 8B, is removed by the recognition that data point 904 has a low statistical quality, and should probably be discounted during interval construction. One embodiment of the present invention displays the log-ratio data using circles with varying radii, as in FIG. 9, to facilitate visual identification of deletion, amplification, and other abnormalities from plots of log-ratio data in loci-occurrence order. In alternative embodiments, plotted, differently sized data points with shapes other than circles may be used for display of the statistical quality of the corresponding data points. In other embodiments, colors, rather than circles of varying radii, may be used to display the statistical quality of plotted data points, and, in yet additional embodiments, a heat-map-like presentation of the data may be employed to concurrently show both log-ratio-value trends as well as the statistical quality of the measured log-ratio values.

One embodiment of the comprehensive interval score is next described. First, the aCGH data is considered to be a vector of log-ratio-value and standard-deviation pairs, as follows:

$$v = ( ( {c}_{1} , {q}_{1} ) , ( {c}_{2} , {q}_{2} ) , … , ( {c}_{n} , {q}_{n} ) )$$

$$where$$

$${q}_{i} = {σ}_{i} = σ ( log ( \frac{{R}_{i}}{{G}_{i}} ) )$$

The magnitudes of the log ratios cᵢ are associated with weights, using the reported standard deviations for the log ratios, qᵢ, as follows:

$${w}_{i} = \frac{1}{{q}_{i}^{2}}$$

A weighted mean for an interval, μ(I), is then defined as:

$$μ ( I ) ≡ \frac{{\sum }_{i ∈ I} {w}_{i} {c}_{i}}{{\sum }_{i ∈ I} {w}_{i}} = \frac{1}{W} {\sum }_{i ∈ I} {w}_{i} {c}_{i}$$

$$where$$

$$W = {\sum }_{i ∈ I} {w}_{i}$$

Two different types of variance are then estimated for the data points in an interval. The first type of variance, σ_{loci}², is defined as follows:

$${σ}_{loci}^{2} ≡ ( {\sum }_{i ∈ I} \frac{1}{{q}_{i}^{2}} ) = \frac{1}{W}$$

This variance is essentially the variance computed from the statistics of pixel intensities reported for the data points in the interval. The corresponding standard deviation, σ_{loci}, is:

$${σ}_{loci} = \frac{1}{\sqrt{W}}$$

A second type of variance, σ_{con}², is defined as:

$${σ}_{con}^{2} ≡ \frac{k}{k - 1} \cdot \frac{{\sum }_{i ∈ I} {{w}_{i} ( {c}_{i} - μ ( I ) )}^{2}}{W}$$

The corresponding standard deviation, σ_{con}, is:
σ_{con}=\sqrt{σ_{con}²}
This second type of variance is related to the variance of measured log ratios of signal intensities about the mean log ratio, μ(I), computed for the interval. This variance is related to the consistency of the measured log ratios within the interval with respect to one another. A combined interval variance is then defined as:

$${σ}^{2} ( I ) ≡ α {σ}_{loci}^{2} + \frac{1}{k} ( 1 - α ) {σ}_{con}^{2}$$

where α is a user-defined parameter.
The corresponding interval standard deviation is then:

$$σ ( I ) = \sqrt{{σ}^{2} ( I )} = {( α {σ}_{loci}^{2} + \frac{1}{k} ( 1 - α ) {σ}_{con}^{2} )}^{\frac{1}{2}}$$

Finally, the comprehensive, quality-based interval score, S_{q}(I), is defined as:

$${S}_{q} ( I ) = \frac{μ ( I )}{σ ( I )}$$

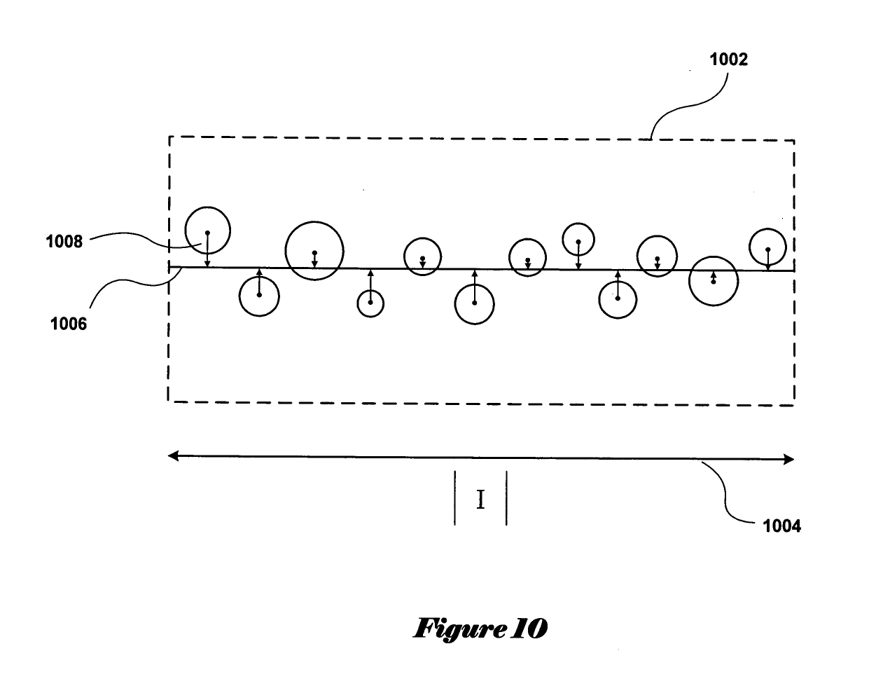

The comprehensive, quality-based interval score, S_{q}(I) favors intervals containing data points of low variance, high consistency with one another, and long lengths. Low values are indicative of deletions, and high values are indicative of amplifications, using the labeling and ratio conventions discussed above with reference to FIGS. 2-4. FIG. 10 illustrates characteristics of an interval of log ratios of signal intensities plotted in loci-occurrence order that contribute to high and low comprehensive, quality-based interval scores, indicative of amplifications and deletions. First, because the numerator of the expression for the comprehensive, quality-based interval score includes the sum of the log ratio values of the data points within the interval, the greater the length 1004 of the interval 1002, when all other parameters are equal, the greater the magnitude of the comprehensive, quality-based interval score. This tends to favor multiple-loci trends, expected for most chromosomal aberrations, since the chromosomal aberrations generally tend to span multiple loci. Because the variance computed for the interval is in the denominator of the expression for the comprehensive, quality-based interval score, the lower the variability of the data points within the interval, the greater the magnitude of the associated comprehensive, quality-based interval score. There are, as discussed above, two types of variance. The first type of variance relates to the pixel-intensity-statistics-based variance of individual data points, represented in FIG. 10 by the radius of the circles used to represent the data points. The larger the radius of the circle, the lower the standard deviation for the data point. Thus, the larger the radii of the data points within the interval, the larger the magnitude of the comprehensive, quality-based interval score. The second type of variance, discussed above, concerns the consistency of the measured log-ratio values within the interval. This is represented by a sum of the squares of the distances of the data points from the computed interval mean, μ(I). These distances are represented in FIG. 10 by directed arrows from the center of the circles representing data points to a horizontal line 1006 representing the interval mean value, μ(I), such as directed arrow 1008. The closer the log ratio data points to the computed mean 1006, the greater the magnitude of the comprehensive, quality-based interval score.

Although the present invention has been described in terms of a particular embodiment, it is not intended that the invention be limited to this embodiment. Modifications within the spirit of the invention will be apparent to those skilled in the art. For example, there are numerous possible ways of computing a comprehensive, quality-based interval score using various statistical-quality metrics. The variance, the standard deviation, distribution widths at half-peak heights, and an almost limitless number of other parameters may be employed in numerous different mathematical expressions to generate comprehensive, quality-based interval scores that factor in both the log-ratio values as well as the variances in log-ratio values in order to produce interval scores that allow for precise, accurate, reliable, and high resolution identification of intervals corresponding to chromosomal abnormalities. The comprehensive, quality-based interval scores may be used in a variety of different recursive and non-recursive interval-identifying methods. The described embodiments are directed to two-label aCGH data, but are straightforwardly extended, by well-known statistical techniques, to aCGH data generated from experiments using three or more labels. Comprehensive, quality-based interval scores are useful for research and diagnostics purposes in identifying chromosomal abnormalities, but may also be employed in many other disciplines and fields, such as evolutionary genetics, population genetics, and other fields in which chromosomes of different tissues and organisms are compared.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for evaluating an interval of measured log-ratio values in a data set for a sequence of genomic loci produced by a comparative genomic hybridization technique, the method comprising:
receiving quality metrics associated with the measured log-ratio values; and
computing a comprehensive, quality-based interval score for the interval from the measured log-ratio values and quality metrics.

2. The method of claim 2 further comprising:
computing an interval metric based on the measured log ratio values within the interval;
computing an interval variance based on the computed interval metric and on the quality metrics; and
computing a comprehensive, quality-based interval score for the interval from the computed interval metric and computed interval variance.

3. The method of claim 2 wherein the interval metric is an interval weighted mean, μ(I), computed as:
$$μ ( I ) ≡ \frac{{\sum }_{i ∈ I} {w}_{i} {c}_{i}}{{\sum }_{i ∈ I} {w}_{i}} = \frac{1}{W} {\sum }_{i ∈ I} {w}_{i} {c}_{i}$$
where cᵢ are the measured log-ratio values for the loci i within the interval I,
qᵢ are the statistical quality metrics associated with the cᵢ , and
$${w}_{i} = \frac{1}{{q}_{i}^{2}} .$$

4. The method of claim 3 wherein the qᵢ are standard deviations associated with the cᵢ.

5. The method of claim 3 wherein the interval variance, σ²(I), is computed as:
$${σ}^{2} ( I ) ≡ α {σ}_{loci}^{2} + \frac{1}{k} ( 1 - α ) {σ}_{con}^{2}$$
$$where {σ}_{loci}^{2} ≡ ( {\sum }_{i ∈ I} \frac{1}{{q}_{i}^{2}} ) = \frac{1}{W} , \\ {σ}_{con}^{2} ≡ \frac{k}{k - 1} \cdot \frac{{\sum }_{i ∈ I} {{w}_{i} ( {c}_{i} - μ ( I ) )}^{2}}{W} , and$$
α is a user-defined parameter.

6. The method of claim 5 wherein the comprehensive, quality-based interval score, S_{q}(I), is computed as:
$${S}_{q} ( I ) = \frac{μ ( I )}{\sqrt{{σ}^{2} ( I )}} .$$

7. The method of claim 1 further including:
using the comprehensive, quality-based interval score, S_{q}(I), to order an interval of measured log-ratio values and associated statistical quality metrics within a list of intervals of measured log-ratio values and associated statistical quality metrics; and
selecting as intervals of measured log-ratio values and associated statistical quality metrics most likely to correspond to gene abnormalities the intervals of measured log-ratio values and associated statistical quality metrics in the list of intervals of measured log-ratio values and associated statistical quality metrics with highest comprehensive, quality-based interval scores.

8. A method for displaying measured log-ratio values and associated statistical quality metrics in a comparative genomic hybridization data set for a sequence of genomic loci, the method comprising one of:
plotting the log-ratio values with respect to loci sequence positions, each log ratio value represented as a shape with a size inversely proportional to the statistical quality metric associated with the log-ratio value;
plotting the log-ratio values with respect to loci sequence positions, each log ratio value represented as a graphical object with a color corresponding to the statistical quality metric associated with the log-ratio value;
displaying the log-ratio values in a color-coded heat map.

9. The method of claim 8 further comprising:
overlaying the plotted log-ratio values with profiles comprising line segments representing intervals of loci-associated log-ratio values identified using comprehensive, quality-based interval scores computed for all possible intervals of loci-associated log-ratio values.

10. A method for analyzing comparative genomic hybridization data, the method comprising:
computing comprehensive, quality-based interval scores for possible DNA-subsequence intervals within a chromosome based on measured signal-intensities, signal-intensity-based data, of labeled fragments bound to the chromosome and on statistical quality metrics associated with the signal intensities, or signal-intensity-based data; and
selecting as regions of amplification or deletion intervals with comprehensive, quality-based interval scores of greatest magnitude.

11. The method of claim 10 further including:
computing interval metrics based on measured log ratio values associated with the possible intervals;
computing interval variances based on the computed interval metrics and on the statistical quality metrics for the possible intervals; and
computing comprehensive, quality-based interval scores for the possible intervals from the computed interval metrics and computed interval variances.

12. The method of claim 11 wherein an interval metric is an interval weighted mean, μ(I), computed as:
$$μ ( I ) ≡ \frac{{\sum }_{i ∈ I} {w}_{i} {c}_{i}}{{\sum }_{i ∈ I} {w}_{i}} = \frac{1}{W} {\sum }_{i ∈ I} {w}_{i} {c}_{i}$$
where cᵢ are the measured log-ratio values for loci i within an interval I,
qᵢ are the statistical quality metrics associated with the cᵢ, and
$${w}_{i} = \frac{1}{{q}_{i}^{2}} .$$

13. The method of claim 12 wherein the qᵢ are standard deviations associated with the cᵢ .

14. The method of claim 12 wherein an interval variance, σ²(I), is computed as:
$${σ}^{2} ( I ) ≡ α {σ}_{loci}^{2} + \frac{1}{k} ( 1 - α ) {σ}_{con}^{2}$$
$$where {σ}_{loci}^{2} ≡ ( {\sum }_{i ∈ I} \frac{1}{{q}_{i}^{2}} ) = \frac{1}{W} , \\ {σ}_{con}^{2} ≡ \frac{k}{k - 1} \cdot \frac{{\sum }_{i ∈ I} {{w}_{i} ( {c}_{i} - μ ( I ) )}^{2}}{W} , and$$
α is a user-defined parameter.

15. The method of claim 14 wherein a comprehensive, quality-based interval score, S_{q}(I), is computed as:
$${S}_{q} ( I ) = \frac{μ ( I )}{\sqrt{{σ}^{2} ( I )}} .$$
